(19) United States
(12) Patent Application Publication
(10) Pub. No.: US 2026/0276379 A1
(43) Pub. Date: Sep. 17, 2026

(54) SURVEYING SYSTEM

(71) Applicant: TOPCON CORPORATION, Itabashi-ku, Tokyo-to (JP)

(72) Inventor: Nobuyuki Nishita, Tokyo-to (JP)

(21) Appl. No.: 19/473,371

(22) PCT Filed: Apr. 9, 2024
(86) PCT No.: PCT/JP2024/014405

§ 371 Date: Oct. 7, 2025

(30) Foreign Application Priority Data
Apr. 11, 2023 (JP) 2023-064518

(51) Int. Cl. G01C 15/00; G01C 5/00

(52) U.S. Cl. CPC G01C 15/004; G01C 5/00

(57) ABSTRACT

A surveying system comprises a height measuring device 1 and a high-low deviation measuring device 2. The high-low deviation measuring device comprises a measurement target 18, a moving vehicle 15, and an unevenness measuring device 14 which is mounted on the moving vehicle, wherein a reference level measuring device constituted of the height measuring device and the measurement target detects a reference level. The high-low deviation measuring device comprises a distance measurement sensor which satisfies a predetermined relationship with measurement target and measures a distance to a construction surface, a projecting device 17 which projects high-low information onto a construction surface, and an arithmetic control module 21, and wherein the arithmetic control module is configured to calculate the high-low information based on the reference level, distance information with respect to the construction surface measured by the distance measurement sensor, and a designed height of a construction finished surface.

### FIELD OF THE INVENTION

The present disclosure relates to a surveying system which determines an unevenness state of a measurement target surface.

### BACKGROUND ART

Concrete placing work or ground leveling work is required to eliminate surface unevenness from working surfaces, referred to as placed surfaces or leveled surfaces, and to construct the surfaces to a specified height.

Conventionally, concrete placing work involves, for instance, height measuring work, in which a worker places a measuring rod on the placed surfaces of the concrete at predetermined spatial intervals to measure the height thereof.

After the height measuring work, the worker determines whether there is surface unevenness on the concrete; if so, the worker instructs correction work to be performed, such as adding concrete to concave portions and removing concrete from convex portions, to make the surface level and/or flat.

These conventional practices require a large number of individual manual height measurements, resulting in poor workability in detecting surface unevenness, and also involve separate and repetitive processes for the concrete placing work, the height measuring work, and the correction work, resulting in poor work efficiency.

Ground leveling work also involves height measuring work in which a worker stretches a string at a predetermined height after the ground leveling to measure the height and detect surface unevenness of the ground surface; if any deviation or unevenness is detected with respect to the specified height, correction work is performed, such as filling or removing soil.

Alternatively, when a leveling material other than concrete, such as sand, gravel, or beads, is placed to correct the surface (which is referred to as “placing work”), a worker also measures the height manually; if any irregularity is detected, correction work is repeatedly performed, such as adding or removing the leveling material.

### CITATION LIST

### Patent Literature

[Patent Literature 1] JP H07-49228 A
[Patent Literature 2] JP 6130078 A
[Patent Literature 3] US 2011/0235053 A
[Patent Literature 4] JP 2005-140523 A
[Patent Literature 5] JP 2006-84346 A
[Patent Literature 6] JP H09-210687 A
[Patent Literature 7] JP 2004-45159 A

### SUMMARY OF INVENTION

### Problems to Be Solved by the Invention

It is an object of the present disclosure to provide a surveying system that can easily measure a deviation or an unevenness state of a measurement target surface with respect to a specified height, and that enables construction work, such as placing work or ground leveling work, to be performed in parallel with the height or unevenness measurement of a measurement target surface.

### Means for Solving the Problems

To attain the object as described above, a surveying system according to the present disclosure comprises a height measuring device and a high-low deviation measuring device, wherein the high-low deviation measuring device comprises a measurement target, a moving vehicle, and an unevenness measuring device which is mounted on the moving vehicle, wherein a reference level measuring device constituted of the height measuring device and the measurement target detects a reference level which satisfies a predetermined relationship with the measurement target, comprises a distance measurement sensor which measures a distance to a construction surface, a projecting device which projects high-low information onto a construction surface, and an arithmetic control module, and wherein the arithmetic control module is configured to calculate the high-low information based on the reference level, distance information with respect to the construction surface measured by the distance measurement sensor, and a designed height of a construction finished surface.

### BRIEF DESCRIPTION OF THE DRAWINGS

FIG. 1 is a schematic diagram of a surveying system according to a first embodiment.

FIG. 2 is a schematic block diagram of a laser level planer according to the first embodiment.

FIG. 3 is a schematic block diagram of a high-low deviation measuring device according to the first embodiment.

FIG. 4 is an explanatory diagram regarding the measurement of an unevenness state according to the first embodiment.

FIG. 5 is a flowchart of unevenness measuring work according to the first embodiment.

FIG. 6 is a schematic diagram of a surveying system according to a second embodiment.

FIG. 7 is a schematic block diagram of a total station according to the second embodiment.

FIG. 8 is a schematic block diagram of a high-low deviation measuring device according to the second embodiment.

FIG. 9 is an explanatory diagram regarding the measurement of an unevenness state according to the second embodiment.

FIG. 10 is a schematic diagram of a surveying system according to a third embodiment.

FIG. 11 is a schematic diagram of a surveying system according to a fourth embodiment.

FIG. 12 is a schematic block diagram of a high-low deviation measuring device in the fourth embodiment.

FIG. 13 is a schematic diagram of a surveying system according to a fifth embodiment.

FIG. 14 is a schematic diagram of the main part of a sixth embodiment.

### DETAILED DESCRIPTION OF THE PREFERRED EMBODIMENT

### Advantageous Effect of Invention

According to the present disclosure, an unevenness state of the measurement target surface can be easily visually confirmed, since the measurement information and the high-low information at the location are directly projected, which enables the construction work, such as the placing work or the ground leveling work, in parallel with the measurement of the unevenness state.

Embodiments of the present disclosure will be described below with reference to the accompanying drawings.

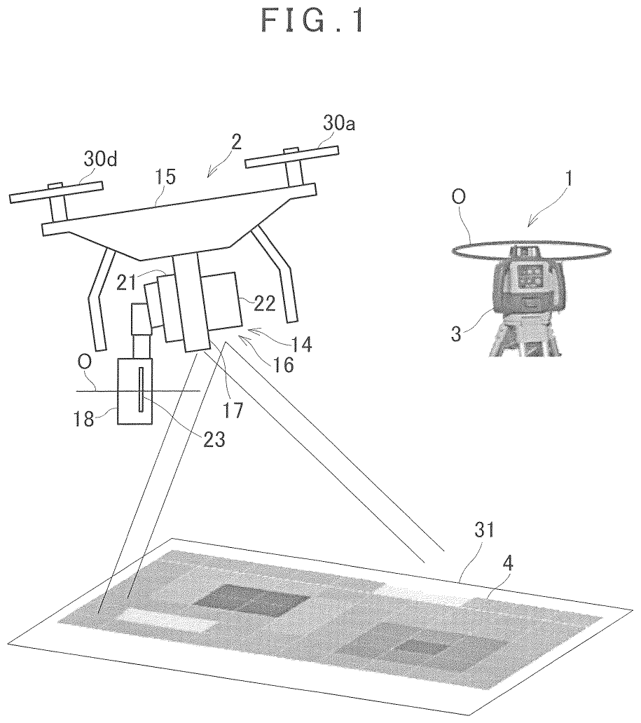

FIG. 1 shows a general diagram of a surveying system according to a first embodiment, and the surveying system is mainly constituted of a height measuring device 1 and a high-low deviation measuring device 2. FIG. 1 also shows an unevenness map 4.

The first embodiment employs a laser level planer 3 as the height measuring device 1.

The laser level planer 3 forms a horizontal reference plane at a predetermined height by using a laser beam. The horizontal reference plane may be formed by rotatably emitting the laser beam on a horizontal plane or may be formed by horizontally emitting a fan-shaped laser beam. The following description relates to an instance in which a horizontal reference plane O is formed by rotatably emitting the laser beam on a horizontal plane.

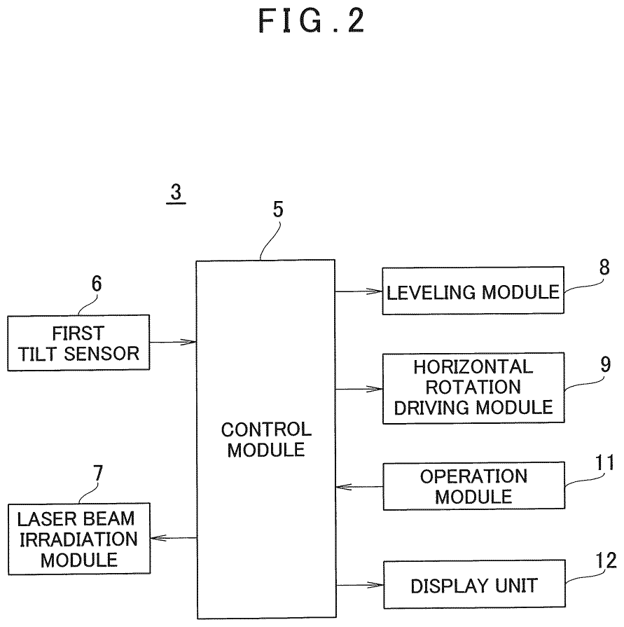

With reference to FIG. 2, general features of the laser level planer 3 will be described below.

The laser level planer 3 is installed at a position using a support device (not shown), such as a tripod. The laser level planer 3 mainly includes a control module 5, a first tilt sensor 6, a laser beam irradiation module 7, a leveling module 8, a horizontal rotation driving module 9, an operation module 11, and a display unit 12.

The first tilt sensor 6 detects the tilt of the laser level planer 3 with respect to the horizontal plane, i.e., the tilt of the laser beam emitted with respect to the horizontal plane. The detection result of the first tilt sensor 6 is input to the control module 5.

Based on the detection result of the first tilt sensor 6, the control module 5 instructs the leveling module 8 to drive and adjust the laser level planer 3 to be horizontal. The control module 5 instructs the laser beam irradiation module 7 to emit the laser beam, and instructs the horizontal rotation driving module 9 to rotate the laser beam irradiation module 7, thereby rotatably emitting the laser beam to form the horizontal reference plane O.

The laser level planer 3 is installed so that the horizontal reference plane O is positioned at a predetermined height. For instance, the height of the horizontal reference plane O from a reference floor surface has been determined from actual measurements or from the specifications of the laser level planer 3. Using the determined horizontal reference plane O allows the laser level planer 3 to measure the height of a measurement target surface and the height of any irregularities on the measurement target surface, with reference to the horizontal reference plane O.

Upon receiving an instruction for the laser level planer 3 via the operation module 11, such as turning it ON/OFF or changing operation condition settings, the display unit 12 displays the operation state.

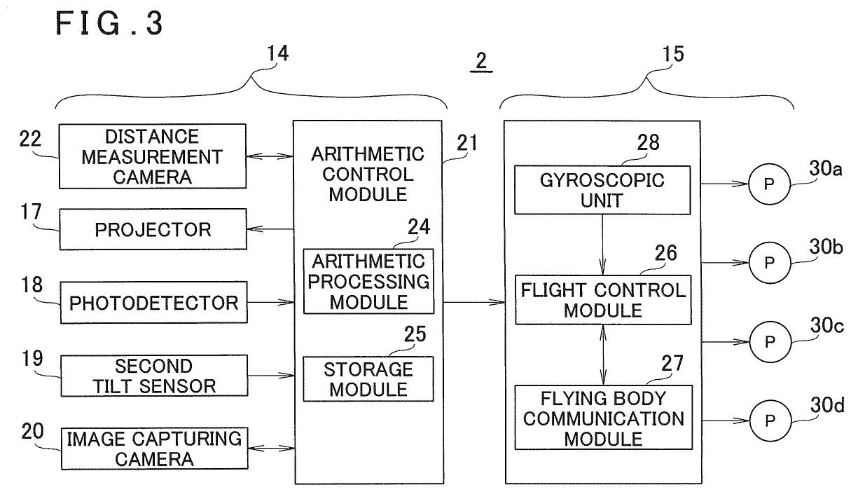

With reference to FIG. 3, the high-low deviation measuring device 2 will be described.

The high-low deviation measuring device 2 includes a moving vehicle, a remote controller, and an unevenness measuring device 14 which is mounted on the moving vehicle. In the first embodiment, the moving vehicle is implemented as a drone 15.

The unevenness measuring device 14 mainly includes a distance measurement sensor 16, a projector 17 serving as a projecting device, a photodetector 18, a second tilt sensor 19, an image capturing camera 20, and an arithmetic control module 21, which are integrally assembled. In some embodiments, the image capturing camera 20 may be omitted.

The distance measurement sensor 16 and the projector 17 have a fixed and predetermined relationship between their optical axes. The distance measurement sensor 16 has a distance measurement range 31 that is configured to be larger than a projection range of the unevenness map 4 projected by the projector 17. The optical axes of the distance measurement sensor 16 and the projector 17 are configured such that the projection range is entirely within the distance measurement range 31.

The optical axes of the distance measurement sensor 16 and the projector 17 are also configured to be aligned vertically when the drone 15 is in a horizontal posture. Alternatively, the optical axes of the distance measurement sensor 16 and the projector 17 may have a predetermined angle (known angle) and an offset when the drone 15 is in a horizontal posture.

The photodetector 18, serving as a measurement target, includes a photodetection sensor 23 extending vertically with a predetermined length and parallel to the optical axis of the distance measurement sensor 16. The photodetection sensor 23 detects the laser beam and outputs a detection signal. The photodetection sensor 23 has a photodetection reference position—for instance, the vertical center or the lower end of the photodetection sensor 23—which is defined as a predetermined position in the high-low deviation measuring device 2. For example, the vertical distance between the photodetection reference position and a distance measurement reference position of the distance measurement sensor 16 is predetermined.

The detection signal includes a photodetection signal and a detection position information. The detection position information includes a deviation in the vertical direction with respect to the photodetection reference position. Based on the detection signal, the high-low deviation measuring device 2 can measure the height (level of the reference position) of the photodetection reference position with respect to the horizontal reference plane O. The detection signal is input to the arithmetic control module 21.

The laser level planer 3, which forms the horizontal reference plane O, and the photodetection sensor 23, which detects the position of the horizontal reference plane O, function together as a reference level measuring device to measure a reference level, which serves as a measurement reference for unevenness measurement.

The distance measurement sensor 16 is oriented downward to measure a distance to the ground surface and may employ various types of sensors. As an example, a distance measurement camera 22 may be used. The distance measurement camera 22, which includes a distance measuring element consisting of many pixels, emits a distance measuring light from each pixel and receives a reflected light at each pixel for the distance measurement based on the Time Of Flight (TOF) principle, thereby acquiring distance measurement data in a planar manner like an image. The distance measurement data output from each pixel includes position information on the distance measuring element. The distance measurement data is input to the arithmetic control module 21. Alternatively, the distance measurement data may also be acquired in a planer manner by performing high-speed two-dimensional scanning of the distance measurement light.

The projector 17 projects the unevenness information, which is described below, onto a measurement target surface.

The distance measurement camera 22 has a measurement reference position, and measures distance from the measurement reference position. Further, as mentioned above, a relationship between the measurement reference position of the distance measurement camera 22 and the photodetection reference position of the photodetection sensor 23 is predetermined.

Thus, the high-low deviation measuring device 2 measures the height of the horizontal reference plane O using the photodetection sensor 23 and thereby can acquire the height of the measurement reference position with respect to the horizontal reference plane O. Further, the high-low deviation measuring device 2 may convert the distance measurement data into distance data with reference to the horizontal reference plane O.

The second tilt sensor 19 detects a tilt of the optical axis of the distance measurement camera 22 with respect to a vertical direction. The tilt detection result from the second tilt sensor 19 is input to the arithmetic control module 21. Further, the arithmetic control module 21 may correct the distance measurement data measured by the distance measurement camera 22 based on a tilt detection result from the second tilt sensor 19 when the drone 15 is tilted.

The second tilt sensor 19 may be incorporated in the arithmetic control module 21. Further, the second tilt sensor 19 may employ various types of inertial measurement unit (IMU) sensors, such as an acceleration sensor or a gyroscope.

The image capturing camera 20 has an optical axis parallel or substantially parallel to that of the distance measurement sensor 16 and a field of view equal to or wider than that of the distance measurement sensor 16, and is configured to acquire an image including the distance measurement range of the distance measurement sensor 16. The acquired image is input to the arithmetic control module 21.

Storing images of a measured location and a construction location acquired by the image capturing camera 20 together with the unevenness information allows a worker to confirm the position and location of the unevenness information from the images.

The arithmetic control module 21 includes an arithmetic processing module 24 and a storage module 25. The arithmetic processing module 24 may employ a dedicated Central Processing Unit (CPU) for the present embodiment, or various other types of processors, including a general-purpose CPU, an embedded CPU, or a microprocessor. The storage module 25 may be implemented using semiconductor memory, such as Random Access Memory (RAM), Read-Only Memory (ROM), Flash ROM, or Dynamic Random Access Memory (DRAM), or magnetic storage memory, such as a Hard Disk Drive (HDD).

The arithmetic processing module 24 executes various types of programs stored in the storage module 25 to perform processing and operations. The arithmetic processing module 24 also controls the photodetector 18, the projector 17, the image capturing camera 20, the distance measurement camera 22, and the storage module 25 to carry out necessary operations at appropriate timings. The arithmetic control module 21 feeds back a detection signal from the photodetector 18, which indicates a laser beam receiving position, to the flight control module 26, as described later.

The storage module 25 stores various types of programs to be executed in the present embodiment. The programs include, for instance, a control program for integrally managing synchronization and other tasks between the distance measurement camera 22 and the projector 17, a program for controlling the projector 17 to project p unevenness information, a distance measurement program for controlling the distance measurement camera 22 to capture images and measure distances, an arithmetic program for calculating the three-dimensional data based on the distance measurement data, a program for calculating unevenness information based on the three-dimensional data.

The storage module 25 also stores various types of data, including a threshold value for determining a high-low state, a measurement result, and image data.

The term “high-low state” refers to a condition that may include a deviation with respect to a specified height of the measurement target surface, surface irregularities (unevenness) with respect to a specified plane, and a tilt with respect to a horizontal plane. The “high-low information” includes data indicating a deviation with respect to the specified height of the measurement target surface, data indicating the unevenness with respect to the specified plane, and a state of a tilt with respect to the horizontal plane.

Next, the drone 15 will be described.

The drone 15 may be a commercially available drone and has the unevenness measuring device 14 mounted on the bottom surface.

The drone 15 includes a flight control module 26, an aircraft communication module 27 and a gyroscopic unit 28, and is configured to fly under remote control via a remote controller (not shown). The flight control module 26 controls the flight posture and attitude of the drone 15 based on a signal from the gyroscopic unit 28. Further, the flight control module 26 may control the height of the drone 15 based on a detection signal of the photodetection sensor 23 fed back from the arithmetic control module 21.

The drone 15 can fly as needed, change and set its direction, and hover under remote control. FIG. 3 shows propeller units 30a, 30b, 30c, 30d, which are driven and power-controlled by the flight control module 26.

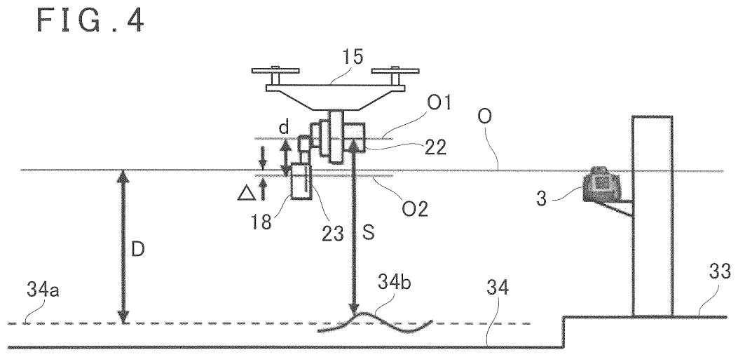

With reference to FIG. 4, a description will be given of an instance in which the measurement target surface is a floor surface and its unevenness state is measured.

In FIG. 4, a floor surface 33 serves as a reference. The laser level planer 3 is installed at a predetermined height with respect to the floor surface 33, and forms a horizontal reference plane O at a predetermined height with respect to the floor surface 33.

A construction floor surface 34, which is lower than floor 33 by a predetermined height, is a floor surface on which concrete is to be placed as a leveling material up to a dashed line in FIG. 4, which indicates a construction finished surface 34a.

A worker operates the drone 15 to fly to a construction position and hover above the construction position.

The following description is based on the assumption that the drone 15 is maintained in a horizontal posture and the optical axes of the distance measurement camera 22 and the projector 17 are each maintained in a vertical posture.

In FIG. 4, horizontal lines O1 and O2 are illustrated, the horizontal line O1 passes through the measurement reference position of the distance measurement camera 22, and the horizontal line O2 passes through the photodetection reference position of the photodetection sensor 23. With respect to the horizontal reference plane Of the construction finished surface 34a is positioned at a height difference D to obtain a predetermined height (designed height) from the construction floor surface 34.

As described above, the measurement reference position and the photodetection reference position have a predetermined positional relationship, and the distance between horizontal lines O1 and O2 is a predetermined value d. A deviation A is defined as the displacement between the laser beam receiving position and the photodetection reference position of the photodetection sensor 23 (i.e., the deviation A between the horizontal reference plane O and the photodetection reference position). A distance measurement value S is defined as the distance measured by the distance measurement camera 22 to the construction surface 34b (i.e., the concrete placing surface), that is, the distance from the measurement reference position of the distance measurement camera 22 to the construction surface 34b.

The unevenness ΔF (i.e., the height difference) of the construction surface 34b with reference to the construction finished surface 34a is defined and calculated using the following expression.

ΔF=D+(d−Δ)−S . . . (expression 1)

In this expression, Δ takes a positive value (+) when the laser beam receiving position is located above the photodetection reference position, and a negative value (−) when it is below. The unevenness ΔF takes a positive value when construction surface 34b is convex relative to the construction finished surface 34a, and a negative value when it is concave.

The height difference D and the distance d between the measurement reference position and the photodetection reference position are preset in the arithmetic control module 21. Distance measurement results from the distance measurement camera 22 and a detection signal of the photodetection sensor 23 are each input to the arithmetic control module 21. The arithmetic control module 21 calculates the unevenness ΔF based on the height difference D, the distance d, the distance measurement results, and the detection signal.

Further, the distance measurement camera 22 may measure distances on a per-pixel basis across the imaging element. The arithmetic control module 21 may calculate the unevenness ΔF on a per-pixel basis, thereby acquiring the unevenness ΔF data (numerical data of high-low) in real time across the full field of view of the distance measurement camera 22. The unevenness ΔF distribution is obtained from the position information including the unevenness ΔF data and the distance measurement data.

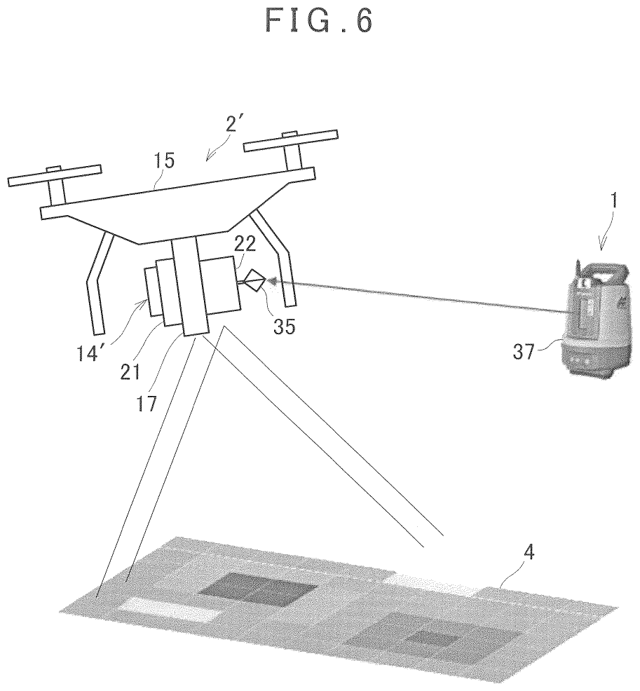

Further, the arithmetic control module 21 may classify the unevenness ΔF using a threshold value stored in the storage module 25, and create an unevenness map 4 (see FIG. 6).

The unevenness map 4 is configured, for instance, as a heat map, to visualize the unevenness ΔF, with colors corresponding to the values of the unevenness ΔF. For instance, when the unevenness ΔF is positive (+) with respect to the construction finished surface 34a, warm colors are used, and the color density or tone may be intensified for every 3 mm increase in the unevenness ΔF. Conversely, when the unevenness ΔF is negative (−) with respect to the construction finished surface 34a, cool colors are used, and the color density or tone may be reduced for each 3 mm decrease.

Alternatively, the threshold value used for the segmentation is not limited to 3 mm and may be set to an appropriate value, such as 5 mm or 1 cm, depending on the application. Alternatively, the threshold value may vary across the surface and gradually increase toward the peripheral region. Alternatively, the segmentation may be represented in a single color with varying shades.

The arithmetic control module 21 stores unevenness information, including the unevenness ΔF data, the unevenness ΔF distribution, and the unevenness map, in the storage module 25. Further, the arithmetic control module 21 outputs the unevenness map 4 to the projector 17 as a video signal so that the unevenness map 4 is projected onto the construction surface 34b in synchronization with the unevenness measurement by the distance measurement camera 22.

The position and range of the projected unevenness map 4 correspond to the position and distance measurement range measured by the distance measurement camera 22, so that the unevenness information of the construction surface 34b is accurately displayed by the unevenness map 4. A worker can visually confirm the unevenness state of the construction surface 34b from the projected unevenness map 4. The unevenness map 4 may be continuously or intermittently projected.

When the unevenness map is projected onto the construction surface 34b during the concrete placing operation, a worker can confirm and correct the unevenness state in real time. Thus, the worker can carry out the concrete placing work while making necessary corrections to the unevenness state.

Further, when the unevenness map is projected onto the construction surface 34b after the concrete has been placed, a worker can confirm the finished condition and the level of accuracy of the construction surface 34b.

In the above description, the drone 15 is assumed to be maintained in horizontal posture. However, in practice, the drone 15 may tilt or shake, and the unevenness measuring device 14 tilts or shakes along accordingly.

On the other hand, the unevenness measuring device 14 includes the second tilt sensor 19, and detects the tilt of the unevenness measuring device 14 in real time, and a tilt detection result is provided and input to the arithmetic control module 21 in real time.

The arithmetic control module 21 corrects, in real time, the measurement results of the distance measurement camera 22 (including a measured distance S shown in FIG. 4 and a measured position) based on the tilt detection result of the second tilt sensor 19. Accordingly, even if the drone 15 tilts or shakes, a corrected unevenness map is projected, and a worker can accurately confirm the high-low information.

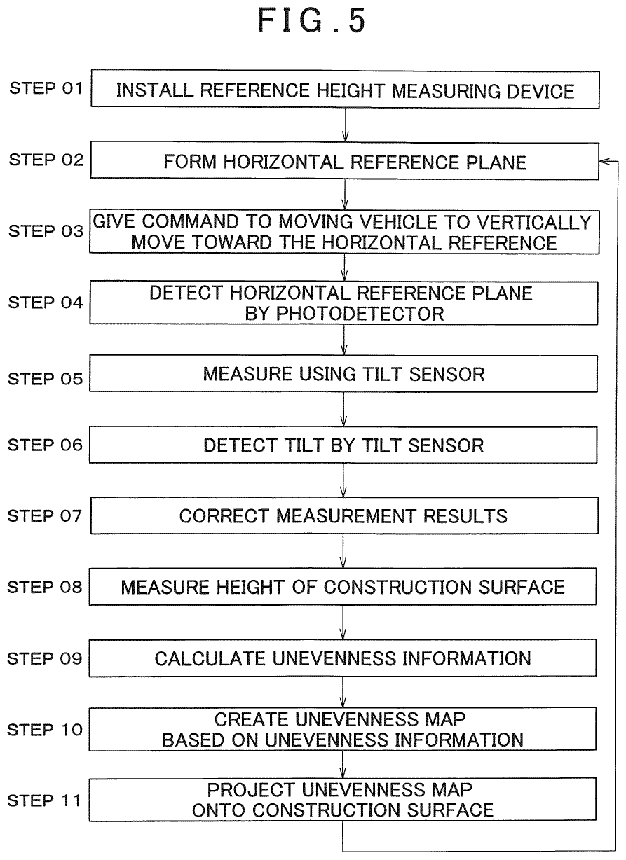

Next, with reference to FIG. 5, the unevenness measuring work will be described.
(Step 01) A worker installs the height measuring device 1 (i.e., the laser level planer 3 in the present embodiment) at a predetermined position. After the leveling operation for the height measuring device 1, the device 1 projects the laser beam to measure the height from a reference position (i.e., a position of the floor surface 33 in the present embodiment) , thereby providing a height value.
(STEP 02) The height measuring device 1 rotatably emits the laser beam onto the horizontal reference plane O.
(STEP 03) A worker instructs the drone 15 from the remote controller to move vertically toward the horizontal reference plane. The drone 15 then moves to a position such that the photodetector 18 can receive the laser beam.
(STEP 04) The height measuring device 1 detects the horizontal reference plane O using the photodetector 18 and obtains the height of the measurement reference position of the distance measurement sensor 16 (the distance measurement camera 22 in the present embodiment) with respect to the horizontal reference plane O, based on the photodetection position of the photodetection sensor 23. The detection result of the horizontal reference surface O is fed back to the flight control module 26 via the arithmetic control module 21, and the flight control module 26 controls the height of the drone 15 such that the photodetection sensor 23 receives a laser beam at the reference position.
(STEP 05) The height measuring device 1 measures the height of the construction surface using the distance measurement sensor 16.
(STEP 06) The height measuring device 1 detects the tilt of the optical axis of the distance measurement sensor 16 using the second tilt sensor 19.
(STEP 07) The height measuring device 1 corrects the measurement results of the distance measurement sensor 16 based on the tilt detection result.
(STEP 08) The height measuring device 1 obtains the height of the construction surface 34b with respect to the horizontal reference plane O, based on the corrected measurement result and the height of the measurement reference position with respect to the horizontal reference plane O.
(STEP 09) The height measuring device 1 calculates the height difference between the construction finished surface 34a, which has been set in advance, and the construction surface 34b, thereby obtaining the high-low information.
(STEP 10) The height measuring device 1 creates an unevenness map image based on the high-low information and threshold values for the segmentation, which have been set in advance.
(STEP 11) The height measuring device 1 calculates a distance between the projector 17 and a projection plane (the construction surface 34b) based on a positional relationship between the distance measurement sensor 16 and the projector 17, and the corrected distance measurement results, thereby allowing the unevenness map image to be projected.

Steps 02 to 11 are repeatedly carried out for acquiring measurement data at other locations.

With reference to FIG. 6 to FIG. 9, a second embodiment will be described.

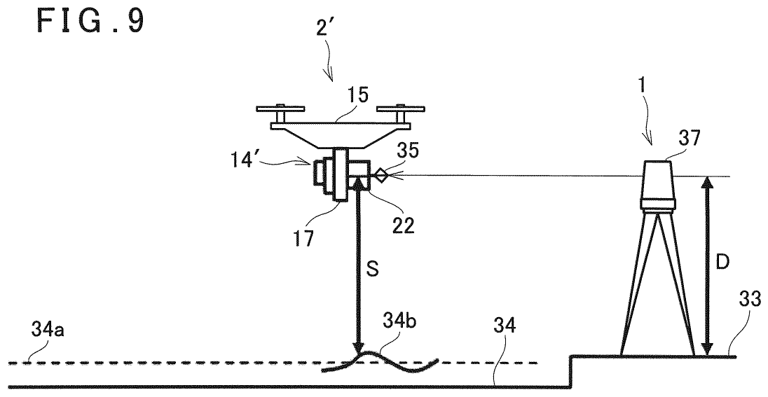

FIG. 6 and FIG. 9 show general diagrams of a surveying system according to the second embodiment. Similar to the first embodiment, the surveying system is mainly constituted of a height measuring device 1 and a high-low deviation measuring device 2′.

In the second embodiment, an electro-optical distance device with a tracking function, such as a total station 37, is used as the height measuring device 1. Nevertheless, other types of the measuring devices with a tracking function, for example, a device with a tracking function based on images captured by an image sensor, or a device with a shape tracking function using a laser scanner may be used.

In FIG. 9, those that are equivalent to components as shown in FIG. 1 are referred by the same numeral, and the detailed description thereof will be omitted.

The total station 37 is installed at a predetermined position and leveled horizontally. The total station 37 is installed at a predetermined height. That is, the total station 37 is installed so as to include a survey reference point, and to provide three-dimensional coordinates of the survey reference point, including height coordinates (height positions) thereof. For instance, with reference to FIG. 9, based on the assumption that the total station 37 is installed on the floor surface 33 and that the height of the floor surface 33 serves as a survey reference height, a height from the floor surface 33 to the survey reference point is provided as height D.

The high-low deviation measuring device 2′, which is similar to the first embodiment, includes a moving vehicle, a remote controller, and an unevenness measuring device 14′ which is mounted on the moving vehicle. The second embodiment. shows an instance in which the drone 15 described in the first embodiment is employed as a moving vehicle.

The high-low deviation measuring device 2′ has a prism 35 with retroreflective characteristics as a measurement target for the height measurement. The position of the optical center of the prism 35 and a measurement reference position of the distance measurement camera 22 have a predetermined positional relationship. The prism 35 may be mounted on the drone 15 or on the unevenness measuring device 14′. In essence, the prism 35 may be mounted on a position that can be sighted from the total station 37. An instance in which the prism 35 is mounted on the distance measurement camera 22 is shown in the diagram. Further, a reflective sheet may be used as a measurement target.

The total station 37 includes a telescope module (not shown) configured to sight the prism 35, emits a tracking light through the telescope module, and tracks the prism 35, Further, the total station 37 emits a distance measuring light through the telescope module, receives a reflected light from the prism 35, and measures three-dimensional electro-optical distance with respect to the prism 35.

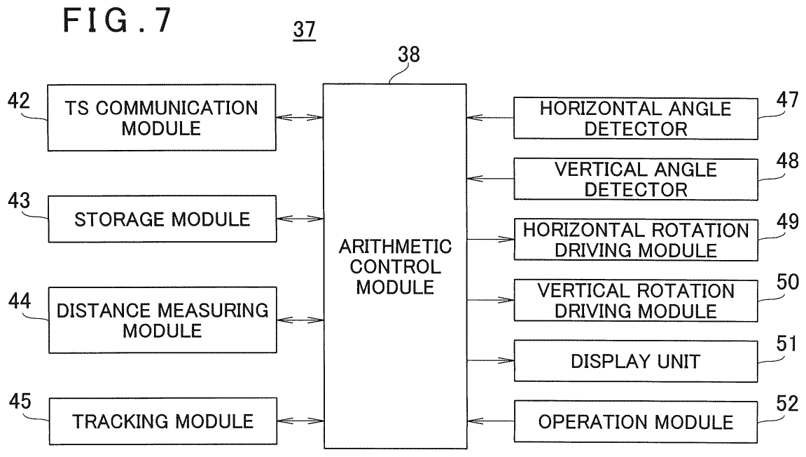

With reference to FIG. 7, a general configuration of the total station 37 will be described.

The total station 37 mainly includes an arithmetic control module 38, a TS communication module 42, a storage module 43, a distance measurement module 44, a tracking module 45, a horizontal angle detector 47, a vertical angle detector 48, a horizontal rotation driving module 49, a vertical rotation driving module 50, a display unit 51, and an operation module 52.

The arithmetic control module 38 controls the TS communication module 42, the distance measuring module 44, the tracking module 45, the horizontal rotation driving module 49, the vertical rotation driving module 50 and the display unit 51 integrally and individually, by drive control or synchronization control.

The TS communication module 42 performs data communication with the unevenness measuring device 14′. The tracking module 45 emits a tracking light to the prism 35 which serves as a tracking target, receives the reflected light, and tracks the tracking target. The TS communication module 42 tracks the tracking module 45, and in parallel, the distance measurement module 44 emits the distance measuring light to the prism 35 as a measurement target, receives the reflected light, and measures the distance to the prism 35 which serves as a measurement target.

The horizontal angle detector 47 has a reference point and is configured to detect the horizontal angle of the optical axis of a telescope with respect. to this reference point. The vertical angle detector 48 is configured to detect a high-low angle with respect to the horizontal plane.

The horizontal rotation driving module 49 and the vertical rotation driving module 50 rotate the telescope in a vertical and horizontal direction, respectively, to track the prism 35. The horizontal angle detector 47 and the vertical angle detector 48 detect a horizontal angle and a vertical angle during distance measurement. Accordingly, the total station 37 measures the distance to a measurement target as well as the three-dimensional coordinates of the measurement target.

The TS communication module 42 transmits, in real time, the measured three-dimensional coordinates to the unevenness measuring device 14′.

Upon receiving an instruction for the total station 37 via the operation module 52, such as turning it ON/OFF or changing operation condition settings, the display unit 12 displays the operation state of the total station 37.

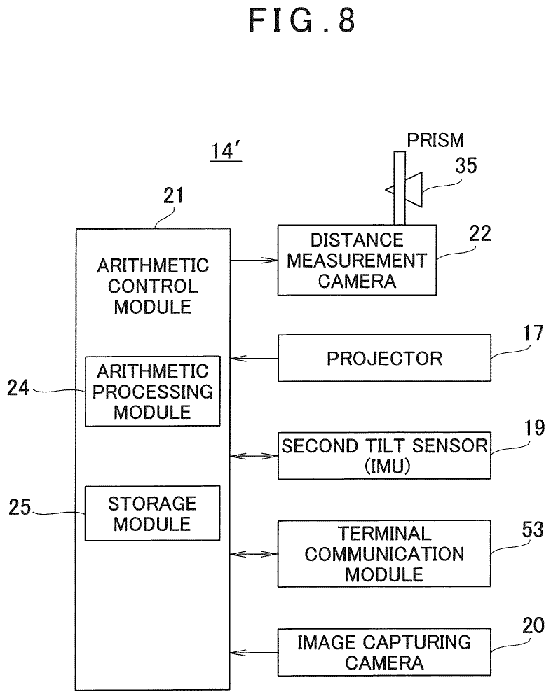

FIG. 8 shows a general diagram of the unevenness measuring device 14′ in the second embodiment. The unevenness measuring device 14′ in the second embodiment and the unevenness measuring device 14 in the first embodiment have substantially the same structure, and the prism 35 is mounted in place of the photodetector 18, Further, the unevenness measuring device 14′ includes a terminal communication module 53 for data communication with the total station 37.

In the second embodiment, the height of the prism 35 measured by the total station 37 serves as an unevenness measurement reference, and the total station 37 and the prism 35 function as a measuring device which measures a reference level which serves as an unevenness measurement reference.

With reference to FIG. 9, the unevenness measurement in the second embodiment will be described. The components in FIG. 9 and the corresponding components shown in FIG. 4 are denoted by the same numeral, and the detailed description thereof will be omitted.

The total station 37 measures the prism 35 and transmits three-dimensional coordinates of the prism 35 as the measurement data from the TS communication module 42 to the terminal communication module 53 of the unevenness measuring device 14′. The terminal communication module 53 outputs the received three-dimensional data to the arithmetic control module 21.

The three-dimensional data is further input to the arithmetic processing module 24, and the arithmetic processing module 24 acquires (calculates) the height. of the prism 35 from the three-dimensional data, that is, the height at which the total station 37 emits the distance measuring light.

The acquired height at which the distance measuring light is emitted corresponds to the height of the prism 35 (i.e., the height of the optical center of the prism 35) with reference to the floor surface 33 (see FIG. 4). The acquired height refers to the reference level.

Further, the arithmetic processing module 24 may acquire the height of the distance measurement camera 22 with reference to the floor surface 33, based on a predetermined positional relationship between the optical center of the prism 35 and the measurement reference position of the distance measurement camera 22, and the height of the prism 35.

Accordingly, the unevenness measuring device 14′ can measure an unevenness state of the construction surface 34b based on the measurement result from the distance measurement camera 22.

The creation of the unevenness map 4 and the projection of an unevenness map image onto the construction surface 34b are equivalent to those of the first embodiment, and hence a description thereof will be omitted.

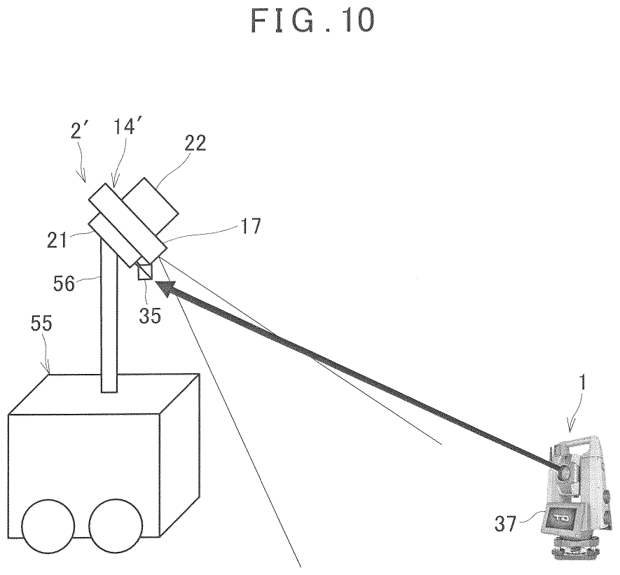

With reference to FIG. 10, a third embodiment will be described.

A surveying system in the third embodiment is constituted of a height measuring device 1 and a high-low deviation measuring device 2′. A total station 37 is used as the height measuring device 1, and the high-low deviation measuring device 2′ is constituted of an unevenness measuring device 14′ and a self-propelled ground vehicle 55 which serves as a moving vehicle.

The total station 37 and the unevenness measuring device 14′ are equivalent to those described in the second embodiment, and hence a description thereof will be omitted.

The ground vehicle 55 can move by itself under remote control. The unevenness measuring device 14′ is mounted on a pole 56 vertically installed on the ground vehicle 55 and includes a prism 35.

An optical center of the prism 35 and a measurement reference point of the unevenness measuring device 14′ have a predetermined relationship. In the third embodiment, optical axes of the distance measurement camera 22 and the projector 17 of the unevenness measuring device 14′ are directed downward and tilt with respect to verticality at a predetermined angle.

The ground vehicle 55 moves to a measurement position or a construction position under remote control.

The total station 37 tracks the prism 35 and determines three-dimensional coordinates of the prism 35 at the measurement position. Further, the total station 37 transmits the measurement results (three-dimensional coordinates) to the unevenness measuring device 14′. The unevenness measuring device 14′ detects the measurement reference level of the unevenness measuring device 14′ based on the received three-dimensional coordinates and measures the unevenness of the construction surface 34b (see FIG. 9).

In the third embodiment, the total station 37 and the prism 35 function as a reference level measuring device to measure a reference level, which serves as a measurement reference for unevenness measurement.

The creation of an unevenness map 4 and the projection of an unevenness map image onto the construction surface 34b are equivalent to those of the first embodiment, and hence a description thereof will be omitted.

Further, a satellite positioning system, such as a GNSS (Global Navigation Satellite System), may be mounted on the moving vehicle. In this instance, the GNSS device serves as a height measuring device when the GNSS device is configured to measure the three-dimensional coordinates of a measurement reference position of the unevenness measuring device 14′, so that use of a laser level planer and a total station can be omitted.

In the third embodiment, the instance in which the ground vehicle 55 is used as a moving vehicle is described. However, the self-moving function may be omitted, and the vehicle may be configured to be moved by a worker.

Next, a tracking function that tracks a person can also be installed on the moving vehicle.

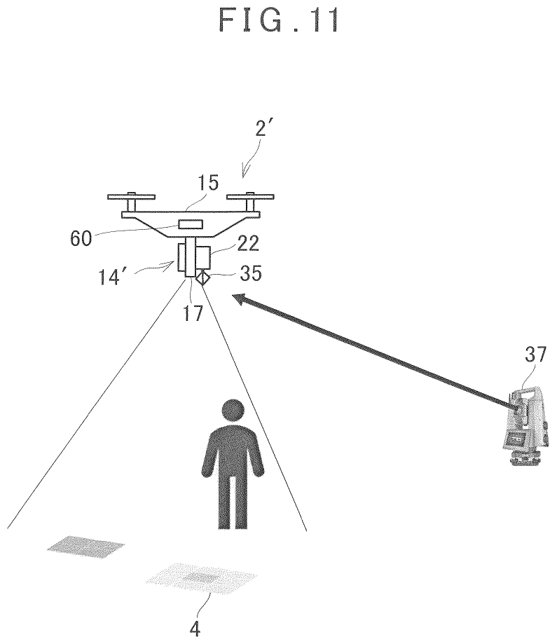

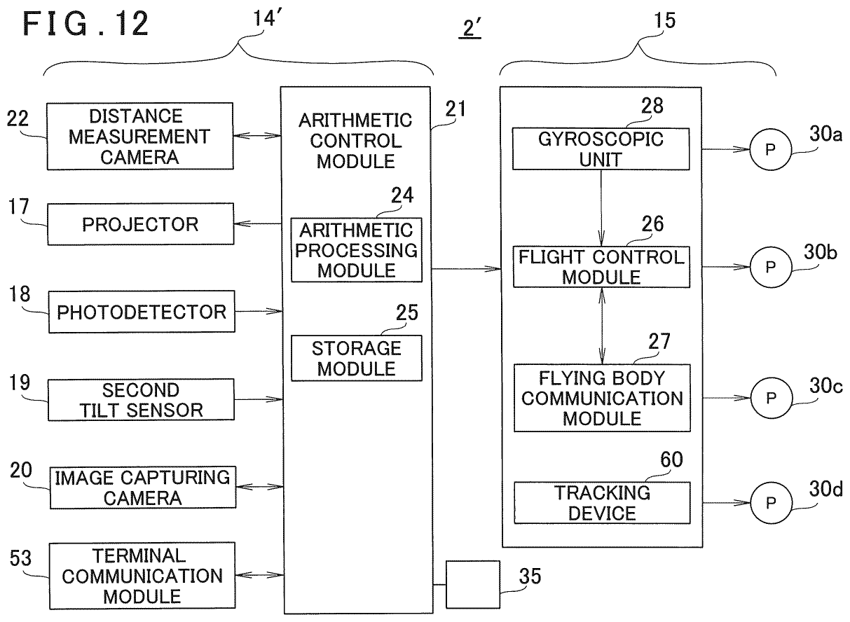

With reference to FIG. 11 and FIG. 12, a fourth embodiment will be described. In the fourth embodiment, a total station 37 is employed as a height measuring device 1, and a drone 15 serving as a moving vehicle includes a tracking device that follows a person's movement. The components in FIG. 11 and FIG. 12 and the corresponding components shown in FIG. 3, FIG. 6, FIG. 8 are denoted by the same numeral, and the detailed description thereof will be omitted.

A commercially available drone 15 includes a tracking device 60 that is configured to recognize a person from an image captured by a camera mounted thereon, detect a person's movement from the image, and follow the person's movement accordingly. In the fourth embodiment, the tracking device 60 of the drone 15 is used.

When a worker moves to a construction location, the tracking device 60 recognizes the worker, follows the worker and moves to the construction location.

When the worker works at the construction location, the tracking device 60 recognizes the working range and the central position of the working range through the worker's movement, and hovers above the central position.

The total station 37 measures the three-dimensional position of the prism 35 mounted on the drone 15 (or the unevenness measuring device 14′) , and transmits distance measurement data to the unevenness measuring device 14′. The unevenness measuring device 14′ acquires a reference level from the received height information of the three-dimensional position. The distance measurement is carried out by the distance measurement camera 22, and a height of the measurement reference position of the unevenness measuring device 14′ is detected based on the reference level, and an unevenness measurement is carried out using the height of the measurement reference position as a reference level.

Further, the height of the measurement reference position is transmitted to a flight control module 26, and the flight control module 26 maintains the drone 15 at an appropriate height.

In the fourth embodiment, the total station 37 and the prism 35 function as a reference level measuring device to measure a reference level, which serves as a measurement reference for unevenness measurement.

After the work completes and a worker moves, the drone 15 follows the worker and moves to the next construction location. For this case, whether the worker is in a construction operation or in a moving motion can be determined based on whether a repetitive motion is included in their operation or not.

Further, the worker may put on a recognition mark to allow easier recognition. For example, the mark may be attached to the upper surface of a helmet. Alternatively, the worker may wear a worker's vest with the mark attached. Alternatively, the mark may be attached to a leveling tool (for example, a leveling float).

Recognition of the working direction and working position becomes easier when a worker wears an identification mark, so that the tracking device 60 would not misidentify the worker even if several workers are working.

In the fourth embodiment, the creation of an unevenness map 4 after unevenness measurement and the projection of an unevenness map image onto a construction surface are equivalent to those of the first embodiment, and hence a description thereof will be omitted.

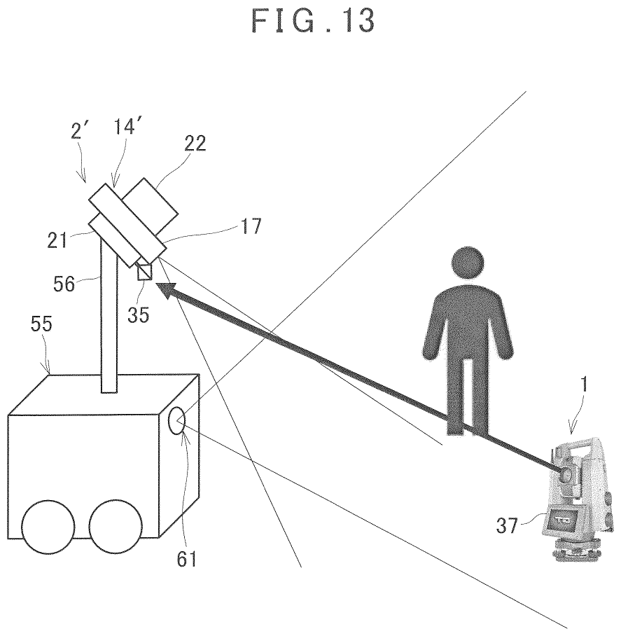

FIG. 13 shows a fifth embodiment which has a configuration similar to the third embodiment and a tracking device 61 which tracks a person is installed on a ground vehicle 55 of the third embodiment.

The tracking device 61 includes a camera, recognizes a worker from an image acquired from the camera and follows a movement of the worker by detecting the movement of the worker from the image.

After the work completes at a predetermined location and when a worker moves to the next construction location, the ground vehicle 55 follows the worker and moves to the next construction location.

The creation of an unevenness map 4 after unevenness measurement and the projection of an unevenness map image onto a construction surface in the fifth embodiment are equivalent to those of the first embodiment, and hence a description thereof will be omitted.

In the first embodiment to the fifth embodiment, in order to acquire height information for measuring a reference position level, a laser level planer 3 or a total station 37 is used. However, when a moving vehicle includes a GNNS device, height information may be acquired from three-dimensional coordinates obtained by the GNNS device and applied as a measurement reference level. Further, the moving vehicle may be configured to identify a working position based on horizontal coordinates of the three-dimensional coordinates.

Additionally, when a moving vehicle includes a SLAM (Simultaneous Localization And Mapping) device or an INS device (Inertial Navigation System), the SLAM device or the INS device may be configured to estimate the current position of the moving vehicle, acquire height information as a measurement reference level based on the current position, or identify the working position.

Nevertheless, when the moving vehicle includes the GNNS device, the SLAM device, or the INS device, use of a height measuring device 1 of a laser level planer 3, a total station 37 or the like may be omitted.

In these embodiments, construction operation of a worker, determination of a moving motion, recognition of a working range and a central position thereof, and a recognition mark which facilitates recognition of a worker are equivalent to those of the fourth embodiment.

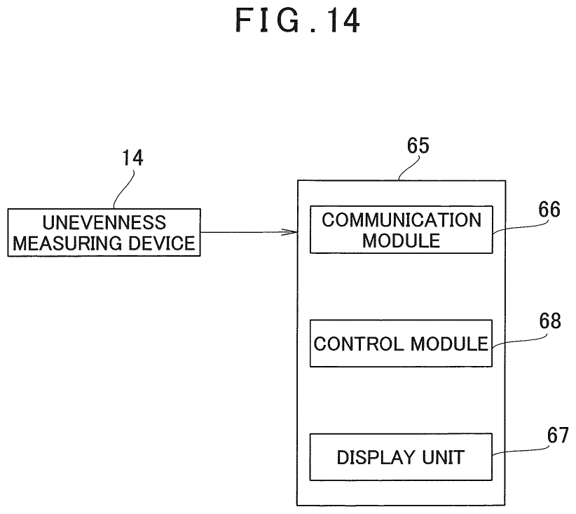

A terminal device 65 may be installed in the surveying system as shown in FIG. 14, which refers to a sixth embodiment. As the terminal device 65, a device such as a smartphone or a mobile PC, which has a communication module 66 and a display unit 67, can be used.

The unevenness measuring device 14 transmits unevenness information data and an unevenness map to the terminal device 65. The terminal device 65 is configured to display the unevenness information data and the unevenness map received from the communication module 66 on the display unit 67. FIG. 14 shows a control module 68 that controls data communication through the communication module 66 and information display of the display unit 67.

Displaying the unevenness information data and the unevenness map on the display unit 67 of the terminal device 65 allows a worker to confirm the unevenness information at any position. In this instance, use of the projector 17 can be omitted.

Although examples for measuring the unevenness on the measurement target surface or the construction surface has been described, it is needless to say that a tilt with respect to the horizontality can be measured by measuring the deviation with respect to the measurement target surface or the specified height of the construction surface (a construction finished surface), or by measuring several points on the construction surface.

Additionally, the present invention can also be implemented when a leveling material is other than concrete, such as sand, gravel or beads.

### Appendix

The above-described embodiments disclose the technical concepts described in the following items.
[Item 1]

A surveying system comprising a height measuring device and a high-low deviation measuring device,
wherein the high-low deviation measuring device comprises a measurement target, a moving vehicle, and an unevenness measuring device which is mounted on the moving vehicle, wherein a reference level measuring device constituted of the height measuring device and the measurement target detects a reference level, satisfies a predetermined relationship with the measurement target, comprises a distance measurement sensor which measures a distance to a construction surface, a projecting device which projects high-low information onto a construction surface, and an arithmetic control module, and
wherein the arithmetic control module is configured to calculate the high-low information based on the reference level, distance information with respect to the construction surface measured by the distance measurement sensor, and a designed height of a construction finished surface.
[Item 2]

The surveying system according to Item 1, wherein the height measuring device forms a horizontal reference plane with a predetermined height, and
wherein the measurement target is a photodetector that detects the horizontal reference plane, and the arithmetic control module is configured to calculate the reference level based on a detected result of the photodetector.
[Item 3]

The surveying system according to Item 1, wherein the measurement target is a prism,
wherein the height measuring device is a surveying instrument which is provided at a predetermined height, has a tracking function and has a TS communication module capable of transmitting measurement results of the measurement target,
wherein the high-low deviation measuring device comprises a terminal communication module capable of receiving measurement results from the TS communication module, and
wherein the arithmetic control module is configured to acquire the measurement results via the terminal communication module and calculate the reference level based on the measurement results.
[Item 4]

The surveying system according to any one of Items 1 to 3, wherein the high-low deviation measuring device further comprises a tilt sensor, and
wherein the arithmetic control module is configured to correct the high-low information based on a detection result of the tilt sensor.
[Item 5]

The surveying system according to Item 1 or 2, wherein the high-low deviation measuring device further comprises a tilt sensor, and
wherein the arithmetic control module is configured to correct distance measurement results of the distance measurement sensor based on a detection result of the tilt sensor.
[Item 6]

The surveying system according to Item 1, wherein the moving vehicle is a drone.
[Item 7]

The surveying system according to Item 1, wherein the moving vehicle is a ground vehicle.
[Item 8]

The surveying system according to Item 1, wherein the moving vehicle comprises a tracking device and is capable of following a person's movement.

### Reference Numeral List

1 Height measuring device
2 High-low deviation measuring device
3 Laser level planer
4 Unevenness map
5 Control module
6 First tilt sensor
14 Unevenness measuring device
15 Drone
17 Projector
18 Photodetector
19 Second tilt sensor
21 Arithmetic control module
22 Distance measurement camera
24 Arithmetic processing module
35 Prism
37 Total station
55 Ground vehicle
60 Tracking device
61 Tracking device

1. A surveying system comprising a height measuring device and a high-low deviation measuring device,
wherein said high-low deviation measuring device comprises a measurement target, a moving vehicle, and an unevenness measuring device which is mounted on said moving vehicle, wherein a reference level measuring device constituted of said height measuring device and said measurement target detects a reference level, wherein said high-low deviation measuring device comprises a distance measurement sensor which satisfies a predetermined relationship with said measurement target and measures a distance to a construction surface, a projecting device which projects high-low information onto a construction surface, and an arithmetic control module, and
wherein said arithmetic control module is configured to calculate said high-low information based on said reference level, distance information with respect to said construction surface measured by said distance measurement sensor, and a designed height of a construction finished surface.

2. The surveying system according to claim 1, wherein said height measuring device forms a horizontal reference plane with a predetermined height, and
wherein said measurement target is a photodetector that detects said horizontal reference plane, and said arithmetic control module is configured to calculate said reference level based on a detected result of said photodetector.

3. The surveying system according to claim 1, wherein said measurement target is a prism,
wherein said height measuring device is a surveying instrument which is provided at a predetermined height, has a tracking function and has a TS communication module capable of transmitting measurement results of said measurement target,
wherein said high-low deviation measuring device comprises a terminal communication module capable of receiving measurement results from said TS communication module, and
wherein said arithmetic control module is configured to acquire said measurement results via said terminal communication module and calculate said reference level based on said measurement results.

4. The surveying system according to claim 1, wherein said high-low deviation measuring device further comprises a tilt sensor, and
wherein said arithmetic control module is configured to correct said high-low information based on a detection result of said tilt sensor.

5. The surveying system according to claim 1, wherein said high-low deviation measuring device further comprises a tilt sensor, and
wherein said arithmetic control module is configured to correct distance measurement results of said distance measurement sensor based on a detection result of said tilt sensor.

6. The surveying system according to claim 1, wherein said moving vehicle is a drone.

7. The surveying system according to claim 1, wherein said moving vehicle is a ground vehicle.

8. The surveying system according to claim 1, wherein said moving vehicle comprises a tracking device and is capable of following a person's movement.

9. The surveying system according to claim 2, wherein said high-low deviation measuring device further comprises a tilt sensor, and
wherein said arithmetic control module is configured to correct said high-low information based on a detection result of said tilt sensor.

10. The surveying system according to claim 3, wherein said high-low deviation measuring device further comprises a tilt sensor, and
wherein said arithmetic control module is configured to correct said high-low information based on a detection result of said tilt sensor.

11. The surveying system according to claim 2, wherein said high-low deviation measuring device further comprises a tilt sensor, and
wherein said arithmetic control module is configured to correct distance measurement results of said distance measurement sensor based on a detection result of said tilt sensor.
